(19) United States
(12) Patent Application Publication
(10) Pub. No.: US 2019/0179744 A1
(43) Pub. Date: Jun. 13, 2019

(54) MEMORY SYSTEM AND OPERATING METHOD THEREOF

(71) Applicant: SK hynix Inc., Gyeonggi-do (KR)

(72) Inventor: Jeen PARK, Gyeonggi-do (KR)

(21) Appl. No.: 16/037,861

(22) Filed: Jul. 17, 2018

(30) Foreign Application Priority Data
Dec. 12, 2017 (KR) 10-2017-0170586

(51) Int. Cl. G06F 12/02

(52) U.S. Cl. CPC G06F 12/0246; G06F 2212/7208; G06F 2212/1016

(57) ABSTRACT

A memory system may include: a controller; and a nonvolatile memory device including memory units, and configured to perform a read operation on the memory units according to control of the controller. The controller may arrange a processing order of the memory units based on an internal read time of each of the memory units, and control the read operation according to the arranged processing order.

### CROSS-REFERENCE TO RELATED APPLICATION

The present application claims priority under 35 U.S.C. § 119(a) to Korean application number 10-2017-0170586, filed on Dec. 12, 2017, in the Korean Intellectual Property Office, the contents of which is incorporated herein by reference in its entirety.

### BACKGROUND

### 1. Technical Field

Various embodiments of the present invention generally relate to a memory system. Particularly, the embodiments relate to a memory system including a nonvolatile memory device.

### 2. Related Art

Memory systems store data provided by an external device in response to a write request. Memory systems may also provide stored data to an external device in response to a read request. Examples of external devices that use memory systems include computers, digital cameras, cellular phones, and the like. A memory system may be embedded in an external device during its manufacture or may be fabricated separately and then connected to an external device.

### SUMMARY

In an embodiment, a memory system may include: a controller; and a nonvolatile memory device including memory units, and configured to perform a read operation on the memory units according to control of the controller. The controller may arrange a processing order of the memory units based on an internal read time of each of the memory units, and control the read operation according to the arranged processing order.

In an embodiment, a memory system may include: a controller; and a nonvolatile memory device including memory units, and configured to perform a read operation on the memory units according to control of the controller. The controller may arrange a processing order of the memory units based on levels of the memory units, and control the read operation according to the arranged processing order.

In an embodiment, a memory system may include: a controller; and a nonvolatile memory device including memory units, and configured to read-access the memory units in parallel at the same time according to control of the controller, and output data read from the memory units to the controller based on an output order. The controller may arrange the output order based on levels of the memory units, when the levels of the memory units are different from each other.

In an embodiment, a memory system may include: a memory device including a plurality of memory units having respective internal read times; and a controller suitable for: arranging a read-request order of the memory units into a processing order based on the internal read times; and controlling the memory device to perform read operations to the memory units in parallel by providing addresses of the memory units according to the arranged processing order. The memory device may provide read data to the controller according to the arranged processing order.

### BRIEF DESCRIPTION OF THE DRAWINGS

FIG. 1 is a block diagram illustrating a memory system in accordance with an embodiment.

FIG. 2 is a block diagram illustrating a detailed configuration of a nonvolatile memory device of FIG. 1 in accordance with an embodiment.

FIG. 3 schematically illustrates a structure of a memory unit in accordance with an embodiment.

FIG. 4 illustrates threshold voltage distributions of memory cells in accordance with an embodiment.

FIG. 5 is a diagram for describing a method in which an order-arranging component of FIG. 1 arranges or reorders a processing order in accordance with an embodiment.

FIG. 6 illustrates a method in which a nonvolatile memory device performs a read operation based on a processing order decided by a controller in accordance with an embodiment.

FIG. 7 is a flowchart describing an operating method of the memory system in accordance with an embodiment.

FIG. 8 is a flowchart describing a read operation method of the nonvolatile memory device in accordance with an embodiment.

FIG. 9 is a diagram illustrating a data processing system including a solid state drive (SSD) in accordance with an embodiment.

FIG. 10 is a diagram illustrating a data processing system including a memory system in accordance with an embodiment.

FIG. 11 is a diagram illustrating a data processing system including a memory system in accordance with an embodiment.

FIG. 12 is a diagram illustrating a network system including a memory system in accordance with an embodiment.

FIG. 13 is a block diagram illustrating a nonvolatile memory device included in a memory system in accordance with an embodiment.

### DETAILED DESCRIPTION

A memory system and an operating method thereof according to embodiments of the present invention will be described with reference to the accompanying drawings. The present invention may, however, be embodied in different forms and thus is not limited to the disclosed embodiments. Rather, these embodiments are provided to enable a person skilled in the art to which the invention pertains to practice the present invention. Moreover, it is to be understood that, throughout the specification, reference to “an embodiment” or the like is not necessarily to only one embodiment, and different references to “an embodiment” or the like are not necessarily to the same embodiment(s).

It is to be understood that embodiments of the present invention are not limited to the particulars shown in the drawings, that the drawings are not necessarily to scale, and, in some instances, proportions may have been exaggerated in order to more clearly depict certain features of the invention. While particular terminology is used, it is to be appreciated that the terminology used is for describing particular embodiments and is not intended to limit the scope of the present invention.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The phrase “at least one of . . . and . . . ,” when used herein with a list of items, means a single item from the list or any combination of items in the list. For example, “at least one of A, B, and C” means, only A, or only B, or only C, or any combination of A, B, and C.

The term “or” as used herein means either one of two or more alternatives but not both nor any combinations thereof.

As used herein, singular forms are intended to include the plural forms and vice versa, unless the context clearly indicates otherwise. It will be further understood that the terms “comprises,” “comprising,” “includes,” and “including” when used in this specification, specify the presence of the stated elements but does not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention pertains in view of the present disclosure. It will be further understood that terms, such as those defined in commonly used dictionaries, should be interpreted as having a meaning that is consistent with their meaning in the context of the present disclosure and the relevant art and not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, an element also referred to as a feature described in connection with one embodiment may be used singly or in combination with other elements of another embodiment, unless specifically indicated otherwise.

Various embodiments of the present invention will be described in detail with reference to the attached drawings.

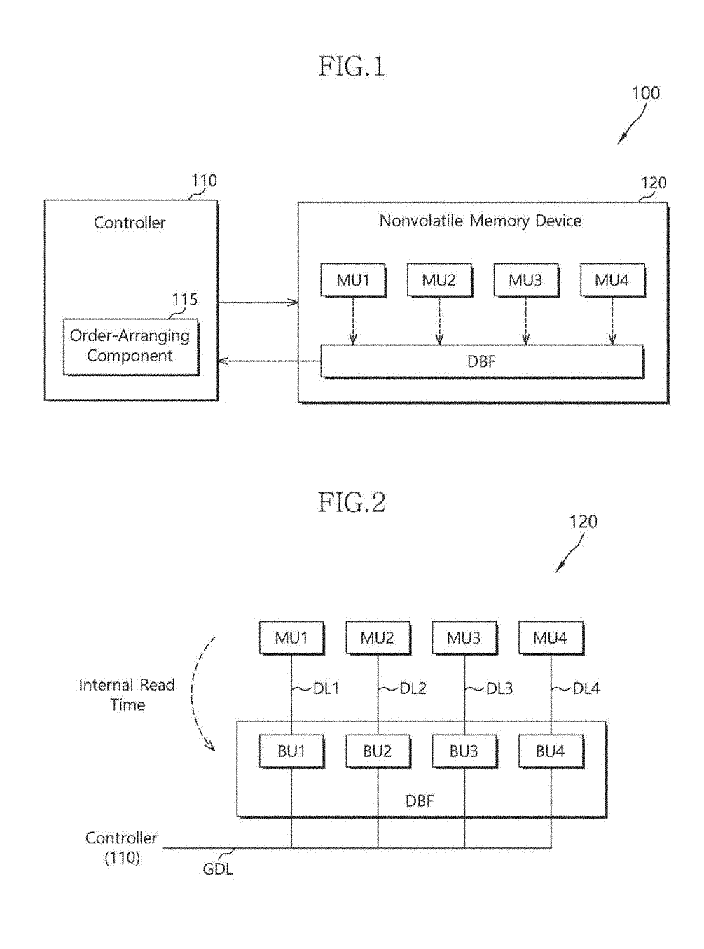

FIG. 1 is a block diagram illustrating a memory system 100 in accordance with an embodiment.

The memory system 100 may be configured to store data provided from a host device, in response to a write request of the host device. Furthermore, the memory system 100 may be configured to provide data stored therein to the host device, in response to a read request of the host device.

The memory system 100 may be embodied as any of a Personal Computer Memory Card International Association (PCMCIA) card, a Compact Flash (CF) card, a smart media card, a memory stick, various multimedia cards (MMC, eMMC, RS-MMC, and MMC-Micro), various secure digital cards (SD, Mini-SD, and Micro-SD), a Universal Flash Storage (UFS), a Solid State Drive (SSD), and the like.

The memory system 100 may include a controller 110 and a nonvolatile memory device 120.

The controller 110 may control overall operations of the memory system 100. The controller 110 may access the nonvolatile memory device 120 in order to process a request from the host device. Furthermore, the controller 110 may access the nonvolatile memory device 120 in order to perform an internal management operation or background operation of the memory system 100, regardless of a request from the host device. The access to the nonvolatile memory device 120 may include a write access and read access. That is, the controller 110 may access the nonvolatile memory device 120 by controlling a write or read operation of the nonvolatile memory device 120.

The controller 110 may decide a processing order for the memory units MU1 to MU4 of the nonvolatile memory device 120, and control the nonvolatile memory device 120 to perform a read operation on the memory units MU1 to MU4 according to the decided processing order. The processing order may indicate an order in which the nonvolatile memory device 120 outputs data read from the memory units MU1 to MU4 to the controller 110. In other words, the nonvolatile memory device 120 may output the data read from the memory units MU1 to MU4 to the controller 110 according to the processing order decided by the controller 110. The controller 110 may sequentially transmit order-arranged read addresses of the memory units MU1 to MU4 to the nonvolatile memory device 120 according to the decided processing order, such that the nonvolatile memory device 120 can recognize the processing order from the order-arranged read addresses.

As described later, the processing order of the memory units MU1 to MU4 may be arranged (which includes reordered) by an order-arranging component 115. When the processing order is not arranged, the non-arranged processing order may be an order of read requests provided from the host device, a predetermined order, or an ascending order of read addresses of the memory units MU1 to MU4. As described later, the order-arranging component 115 may arrange the processing order when an improvement in performance of a read operation or response speed, e.g., of the host, is desired.

The controller 110 may include the order-arranging component 115. The order-arranging component 115 may arrange the processing order of the memory units MU1 to MU4 based on internal read times of the memory units MU1 to MU4. The internal read time of a memory unit may indicate a time required for reading data from the corresponding memory unit into a data buffer DBF. The order-arranging component 115 may arrange the processing order in ascending order of the internal read times of the memory units MU1 to MU4.

In another embodiment, the order-arranging component 115 may arrange the processing order of the memory units MU1 to MU4 based on the levels of the memory units MU1 to MU4. The level of a memory unit may depend on the level of a bit stored in the corresponding memory unit, among bits of a multi-level memory cell. The internal read times of the memory units may differ depending on the levels of the memory units. Therefore, in order to arrange the processing order according to the internal read times of the memory units MU1 to MU4, the order-arranging component 115 may detect the levels of the memory units MU1 to MU4, and arrange the processing order based on the detected levels. That is, the order-arranging component 115 may arrange the processing order in ascending order of the internal read times, which are identified through the detected levels of the memory units MU1 to MU4.

The nonvolatile memory device 120 may include the memory units MU1 to MU4 and the data buffer DBF. The nonvolatile memory device 120 may perform a read operation on the memory units MU1 to MU4 according to control of the controller 110. The nonvolatile memory device 120 may perform a read operation on the memory units MU1 to MU4 based on the arranged processing order decided by the controller 110. The nonvolatile memory device 120 may recognize the arranged processing from the order-arranged read addresses of the memory units MU1 to MU4, which are transmitted with a read command from the controller 110.

Specifically, during the read operation, the nonvolatile memory device 120 may access the memory units MU1 to MU4 in parallel at the same time. The data stored in the memory units MU1 to MU4 may be read out into the data buffer DBF. The nonvolatile memory device 120 may sequentially output the data read from the memory units MU1 to MU4, that is, the data stored in the data buffer DBF to the controller 110 according to the processing order.

As described above, the internal read time of a memory unit may indicate a time required for reading data from the corresponding memory unit into the data buffer DBF. The internal read time of the memory unit may depend on the level of the memory unit. The internal read time of the memory unit may depend on the number of read voltages applied to the memory unit during a read operation.

The nonvolatile memory device 120 may include any of a flash memory, such as a NAND flash or a NOR flash, a Ferroelectrics Random Access Memory (FeRAM), a Phase-Change Random Access Memory (PCRAM), a Magnetoresistive Random Access Memory (MRAM), a Resistive Random Access Memory (ReRAM), and the like.

FIG. 1 illustrates that the memory system 100 includes one nonvolatile memory device 120, but the number of nonvolatile memory devices included in the memory system 100 is not limited thereto.

Moreover, FIG. 1 illustrates that the nonvolatile memory device 120 includes four memory units MU1 to MU4, but the number of memory devices included in the nonvolatile memory device 120 is not limited thereto.

Furthermore, FIG. 1 illustrates that the nonvolatile memory device 120 accesses four memory units MU1 to MU4 in parallel to each other, but the number of memory units which the nonvolatile memory device 120 can access in parallel is not limited thereto. Therefore, the number of memory units of which the processing order is arranged by the order-arranging component 115 is not limited to four.

In accordance with an embodiment, the controller 110 may arrange the processing order of the memory units MU1 to MU4, and reduce time required to complete the output of the data read from the memory units MU1 to MU4 into the data buffer DBF. Therefore, the performance of the read operation and the response speed can be improved.

FIG. 2 is a block diagram illustrating the detailed configuration of the nonvolatile memory device 120 of FIG. 1 in accordance with an embodiment.

Referring to FIG. 2, the nonvolatile memory device 120 may include the memory units MU1 to MU4 and the data buffer DBF.

The memory units MU1 to MU4 may be included in different memory blocks or different planes in the nonvolatile memory device 120. The memory units MU1 to MU4 may be accessed in parallel because the memory units MU1 to MU4 are coupled to the data buffer DBF through data lines DL1 to DL4, respectively.

The data buffer DBF may include buffer units BU1 to BU4. The buffer units BU1 to BU4 may be coupled to the memory units MU1 to MU4 through the data lines DL1 to DL4, respectively. The buffer units BU1 to BU4 may be coupled to the controller 110 through a global data line GDL.

The nonvolatile memory device 120 may perform a read operation on the memory units MU1 to MU4 through the following method.

The nonvolatile memory device 120 may read-access the memory units MU1 to MU4 in parallel at the same time. The data read from the memory units MU1 to MU4 may be stored in the buffer units BU1 to BU4 through the data lines DL1 to DL4, respectively.

The data stored in the buffer units BU1 to BU4 may be sequentially transmitted to the controller 110 through the global data line GDL. As described above, the nonvolatile memory device 120 may sequentially transmit the data stored in the buffer units BU1 to BU4 to the controller 110 according to the processing order arranged by the controller 110.

The internal read time of a memory unit may indicate a time required for reading data from the memory unit into the corresponding buffer unit. The internal read times of the respective memory units MU1 to MU4 may be different from each other as described later. Therefore, although the memory units MU1 to MU4 are simultaneously accessed in parallel when a read operation is performed, the times that data are completely stored in the buffer units BU1 to BU4 may be different from each other.

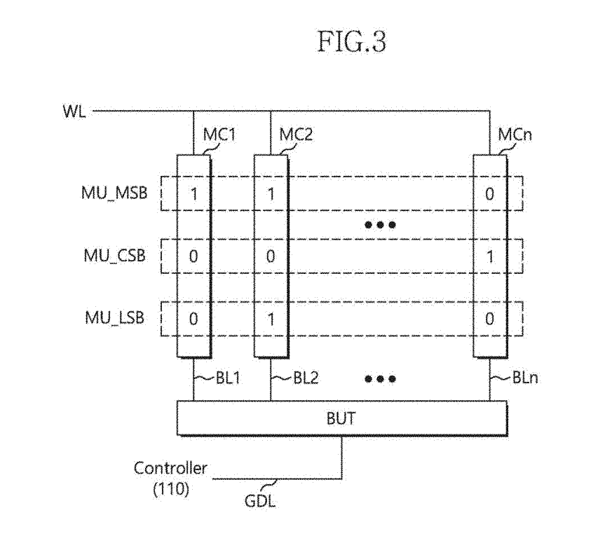

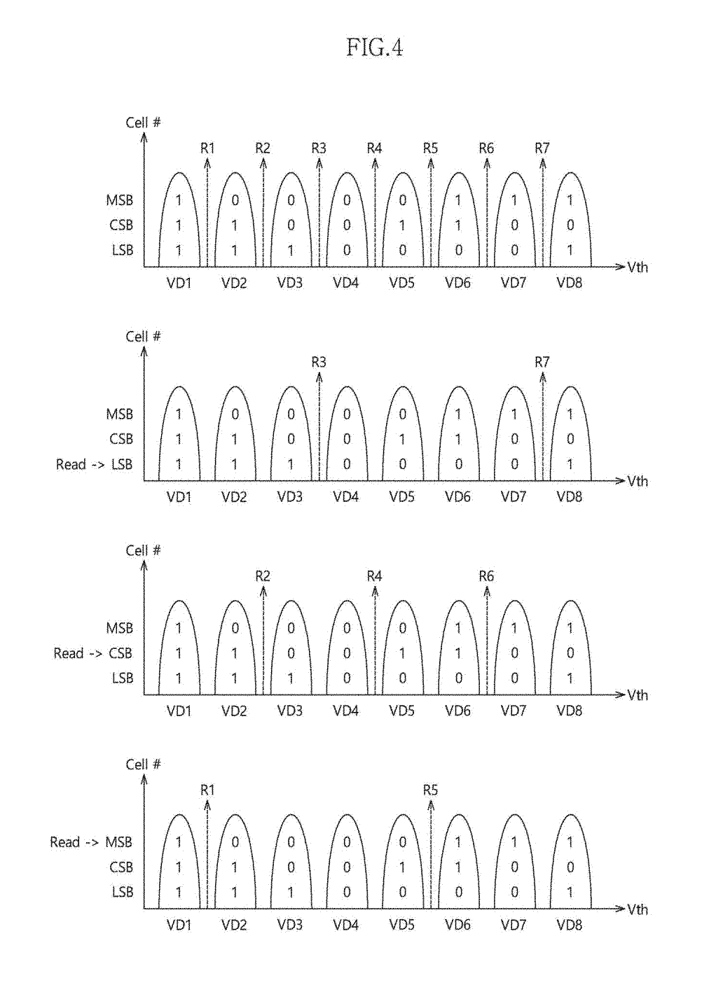

FIG. 3 schematically illustrates the structure of the memory unit in accordance with an embodiment.

Referring to FIG. 3, a memory unit of the nonvolatile memory device 120 may include memory cells MC1 to MCn in which data are stored. The memory cells MC1 to MCn may be commonly coupled to a word line WL and respectively coupled to bit lines BL1 to BLn. The memory cells MC1 to MCn may be coupled to a corresponding buffer unit BUT through the bit lines BL1 to BLn. In another embodiment, the memory unit may further include other memory cells and control transistors between the memory cells MC1 to MCn and the bit lines BL1 to BLn. In FIG. 3, however, the other memory cells and the control transistors are not illustrated for clarity.

The buffer unit BUT may correspond to any one of the buffer units BU1 to BU4 of FIG. 2. The bit lines BL1 to BLn may constitute any one of the data lines DL1 to DL4 of FIG. 2.

The memory cells MC1 to MCn may be accessed at the same time as the common word line WL is enabled. The memory cells MC1 to MCn may exchange data with the buffer unit BUT through the bit lines BL1 to BLn.

As illustrated in FIG. 3, a multi-level memory cell may store a plurality of bits, for example, three bits. For example, the memory cell MC1 may store the least significant bit (LSB) of “0”, the central significant bit (CSB) of “0” and the most significant bit (MSB) of “1”.

The LSB, CSB and MSB stored in a memory cell may be stored in logical memory units MU_LSB, MU_CSB and MU_MSB, respectively, which are distinguished from each other. For example, the LSB may be stored in the least-significant-level memory unit MU_LSB, the CSB may be stored in the central-significant-level memory unit MU_CSB, and the MSB may be stored in the most-significant-level memory unit MU_MSB. The level of a memory unit may depend on the level of a bit stored therein. The memory units MU_LSB, MU_CSB and MU_MSB formed across the memory cells MC1 to MCn may be distinguished from each other by their levels.

The memory unit may correspond to a page of the nonvolatile memory device 120, for example.

The number of bits stored in each memory cell is not limited to three bits as illustrated in FIG. 3. When i bits are stored in each memory cell, the i bits may be stored in memory units having i different levels, respectively.

Each of the memory units MU_LSB, MU_CSB and MU_MSB may be accessed through the corresponding address. The nonvolatile memory device 120 may select a memory unit based on an address transmitted from the controller 110, read data stored in the memory unit, and store the read data in the buffer unit BUT. For example, when the memory unit MU_CSB is selected, the CSBs stored in the memory cells MC1 to MCn may be read and stored in the buffer unit BUT. The internal read times of the memory units MU_LSB, MU_CSB and MU_MSB may be different from each other as described later.

FIG. 4 illustrates threshold voltage distributions VD1 to VD8 of the memory cells in accordance with an embodiment. The threshold voltage distributions VD1 to VD8 may be formed by the memory cells MC1 to MCn of FIG. 3, for example. In FIG. 4, the horizontal axis Vth may indicate the threshold voltages of the memory cells, and the vertical axis Cell # may indicate the number of memory cells for each threshold voltage.

Referring to FIGS. 3 and 4, the memory cells may form the threshold voltage distributions VD1 to VD8 according to data stored therein. Each of the memory cells may be controlled to have a threshold voltage corresponding to any one of the eight threshold voltage distributions VD1 to VD8, depending on 3-bit data stored therein. For example, a memory cell in which data “111” is stored may have a threshold voltage corresponding to the threshold voltage distribution VD1. Furthermore, a memory cell in which data “011” is stored may have a threshold voltage corresponding to the threshold voltage distribution VD2.

The number of bits stored in each of the memory cells is not limited to three bits as illustrated in FIG. 4. When i bits are stored in each of the memory cells, the memory cells may form 2′ threshold voltage distributions.

Each of the memory cells may be turned on/off according to its threshold voltage and a read voltage applied to it through the word line WL. Specifically, the memory cell may be turned on when a read voltage higher than the threshold voltage thereof is applied, or turned off when a read voltage lower than the threshold voltage thereof is applied.

In this case, the nonvolatile memory device 120 may sense a current which is formed when the memory cell is turned on/off, and thus determine whether the threshold voltage of the memory cell is higher or lower than the read voltage. Therefore, when read voltages R1 to R7 having levels between the respective adjacent threshold voltage distributions VD1 to VD8 are applied to the memory cell, the nonvolatile memory device 120 may determine whether the threshold voltage of the memory cell is higher or lower than the read voltages R1 to R7. In other words, the nonvolatile memory device 120 may determine which threshold voltage distributions the memory cells have, using the read voltages R1 to R7. As a result, the nonvolatile memory device 120 may read the data stored in the memory cells.

For example, when performing a read operation on the least-significant-level memory unit MU_LSB, the nonvolatile memory device 120 may apply the read voltages R3 and R7 to the memory cells M1 to MCn. Then, the nonvolatile memory device 120 may sense a current formed through a turned-on/off memory cell, and compare the threshold voltage of the corresponding memory cell to the read voltages R3 and R7. The nonvolatile memory device 120 may determine that the LSB stored in the memory cell is “1” when the threshold voltage of the memory cell is lower than the read voltage R3, determine that the LSB stored in the memory cell is “0” when the threshold voltage of the memory cell is higher than the read voltage R3 and lower than the read voltage R7, and determine that the LSB stored in the memory cell is “1” when the threshold voltage of the memory cell is higher than the read voltage R7.

For another example, when performing a read operation on the central-significant-level memory unit MU_CSB, the nonvolatile memory device 120 may apply the read voltages R2, R4 and R6 to the memory cells M1 to MCn. Then, the nonvolatile memory device 120 may sense a current formed through a turned-on/off memory cell, and compare the threshold voltage of the corresponding memory cell to the read voltages R2, R4 and R6. The nonvolatile memory device 120 may determine that the CSB stored in the memory cell is “1” when the threshold voltage of the memory cell is lower than the read voltage R2, determine that the CSB stored in the memory cell is “0” when the threshold voltage of the memory cell is higher than the read voltage R2 and lower than the read voltage R4, determine that the CSB stored in the memory cell is “1” when the threshold voltage of the memory cell is higher than the read voltage R4 and lower than the read voltage R6, and determine that the CSB stored in the memory cell is “0” when the threshold voltage of the memory cell is higher than the read voltage R6.

For another example, when performing a read operation on the most-significant-level memory unit MU_MSB, the nonvolatile memory device 120 may apply the read voltages R1 and R5 to the memory cells M1 to MCn. Then, the nonvolatile memory device 120 may sense a current formed through a turned-on/off memory cell, and compare the threshold voltage of the corresponding memory cell to the read voltages R1 and R5. The nonvolatile memory device 120 may determine that the MSB stored in the memory cell is “1” when the threshold voltage of the memory cell is lower than the read voltage R1, determine that the MSB stored in the memory cell is “0” when the threshold voltage of the memory cell is higher than the read voltage R1 and lower than the read voltage R5, and determine that the MSB stored in the memory cell is “1” when the threshold voltage of the memory cell is higher than the read voltage R5.

As such, the number of read voltages used during the read operation may be different depending on the levels of the memory units. The internal read time required for reading data from a memory unit into the data buffer DBF may increase as the number of applied read voltages increases.

In the embodiment of FIG. 4, the central-significant-level memory unit MU_MSB using three read voltages R2, R4 and R6 may have a longer internal read time than the least-significant-level memory unit MU_MSB or the most-significant-level memory unit MU_MSB using two read voltages.

The internal read time may be affected by various factors such as the circuit structure as well as the number of read voltages. As a result, the memory units may have different internal read times depending on the levels thereof. The internal read times of the memory units having different levels may be measured in advance, for example, through an experiment. For example, the least-significant-level memory unit MU_LSB may have a shorter internal read time than the most-significant-level memory unit MU_MSB. In this case, when the three-level memory units MU_LSB, MU_CSB and MU_MSB are arranged in ascending order of the internal read times, the least-significant-level memory unit MU_LSB, the most-significant-level memory unit MU_MSB and the central-significant-level memory unit MU_CSB may be sequentially arranged.

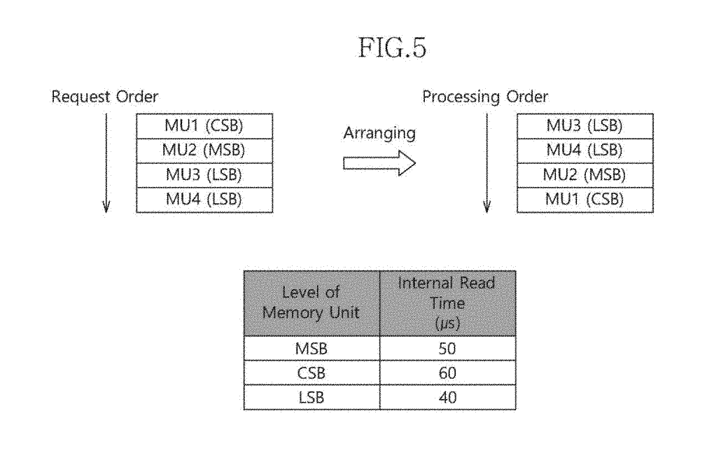

FIG. 5 is a diagram for describing the method in which the order-arranging component 115 of FIG. 1 arranges, which may be reordering, the processing order in accordance with an embodiment.

Referring to FIGS. 1 and 5, the controller 110 may receive read requests from the host device in order of the memory units MU1 to MU4, for example. The levels of the memory units MU1 to MU4 may not be the same as each other as illustrated in FIG. 5.

The internal read times of the memory units MU1 to MU4 may be different from each other. As illustrated in FIG. 5, the least-significant-level memory unit MU_LSB may have the shortest internal read time, the central-significant-level memory unit MU_LSB may have the greatest internal read time, and the most-significant-level memory unit MU_MSB may have an internal read time between those of the MU_LSB and the MU_CSB.

The order-arranging component 115 may arrange the processing order of the memory units MU1 to MU4. The order-arranging order 115 may arrange the processing order in ascending order of the internal read times. That is, since the least-significant-level memory units MU3 and MU4 have a relatively short internal read time, the least-significant-level memory units MU3 and MU4 may lead in the processing order. Furthermore, since the central-significant-level memory unit MU1 has a relatively long internal read time, the central-significant-level memory unit MU1 may be positioned at the end of the processing order.

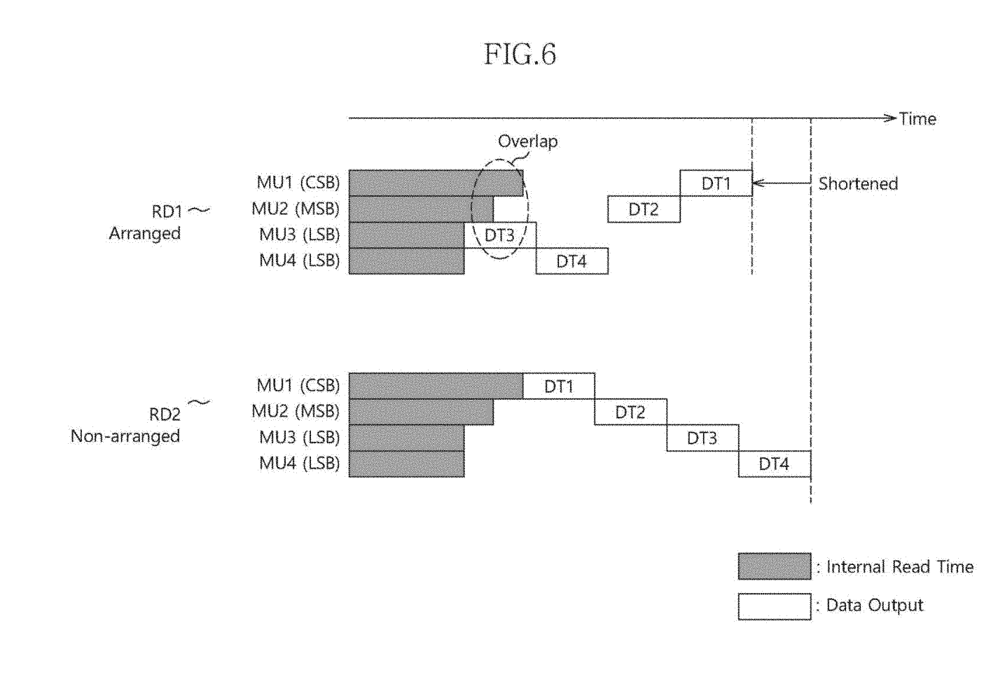

FIG. 6 illustrates the method in which the nonvolatile memory device 120 performs a read operation based on the processing order arranged by the controller 110 in accordance with an embodiment.

Referring to FIG. 6, a first situation RD1 may indicate that the nonvolatile memory device 120 performs a read operation based on the processing order arranged as illustrated in FIG. 5. The nonvolatile memory device 120 may access the memory units MU1 to MU4 in parallel at the same time, according to control of the controller 110. However, since the internal read times are different from each other depending on the levels of the memory units, the times in which data are completely stored in the data buffer BF may be different.

According to the arranged processing order, data corresponding to a relatively short internal read time may be first outputted. Therefore, the nonvolatile memory device 120 may first output data DT3 and DT4 read from the memory units MU3 and MU4. The output of the data DT3 may overlap a read access to the memory units MU1 and MU2 having a relatively long internal read time. As a result, the performance time of the read operation may be shortened by the time corresponding to the overlap between the output of the data DT3 and the read access to the memory units MU1 and MU2.

A second situation RD2 may indicate that the nonvolatile memory device 120 performs a read operation based on a non-arranged processing order. For example, the processing order of the second situation RD2 may coincide with an order in which read requests for the memory units MU1 to MU4 are received from the host device.

In this case, the nonvolatile memory device 120 may also access the memory units MU1 to MU4 in parallel at the same time, according to control of the controller 110. However, the nonvolatile memory device 120 may sequentially output data DT1 to DT4 read from the memory units MU1 to MU4 based on the non-arranged processing order. As a result, the performance time of the read operation may be longer than in the first situation RD1.

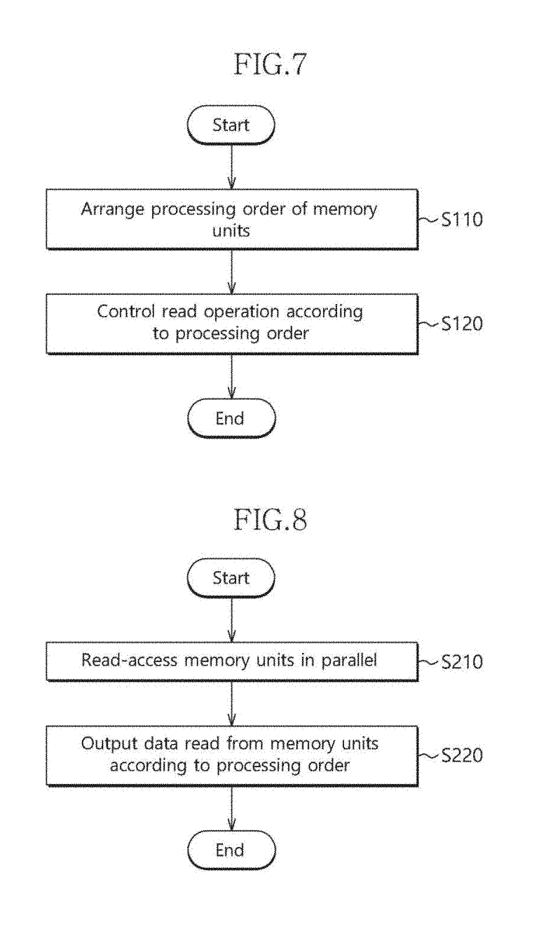

FIG. 7 is a flowchart describing an operating method of the memory system 100 in accordance with an embodiment.

Referring to FIGS. 1 and 7, the controller 110 may arrange a processing order of the memory units MU1 to MU4 at step S110. As previously noted, such arranging may entail reordering. The controller 110 may arrange the processing order based on the internal read times of the memory units MU1 to MU4. The internal read time may indicate a time required for reading data from the corresponding memory unit into the data buffer DEW. The controller 110 may arrange the processing order in ascending order of the internal read times of the memory units MU1 to MU4.

The internal read times of the memory units may depend on the levels of the memory units. Therefore, the controller 110 may arrange the processing order in ascending order of the internal read times, based on the levels of the memory units MU1 to MU4.

At step S120, the controller 110 may control the read operation of the nonvolatile memory device 120 according to the arranged processing order. The controller 110 may sequentially transmit the addresses of the memory units MU1 to MU4 to the nonvolatile memory device 120 according to the arranged processing order, in order to control the read operation of the nonvolatile memory device 120.

FIG. 8 is a flowchart describing a read operation method of the nonvolatile memory device 120 in accordance with an embodiment.

Referring to FIG. 8, the nonvolatile memory device 120 may read-access the memory units MU1 to MU4 in parallel, according to control of the controller 110, at step S210. The nonvolatile memory device 120 may read-access the memory units MU1 to MU4 at the same time. The data read from the memory units MU1 to MU4 may be stored in the data buffer DBF.

At step S220, the nonvolatile memory device 120 may sequentially output the data read from the memory units MU1 to MU4 to the controller 110 according to the processing order decided by the controller 110.

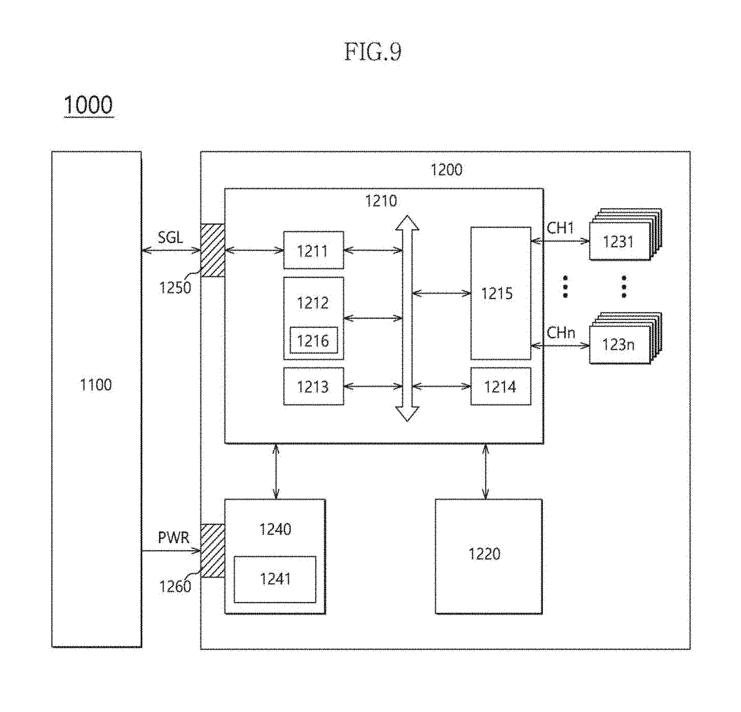

FIG. 9 is a diagram illustrating a data processing system 1000 including a solid state drive (SSD) 1200 in accordance with an embodiment. Referring to FIG. 9, the data processing system 1000 may include a host device 1100 and the SSD 1200.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operations of the SSD 1200. The controller 1210 may operate similarly to the controller 110 shown in FIG. 1. For example, a control component 1212 in the controller 1210 may include an order-arranging component 1216. The order-arranging component 1216 may be configured in the same manner as the order-arranging component 115 shown in FIG. 1.

The controller 1210 may include a host interface unit 1211, a control component 1212, a random access memory 1213, an error correction code (ECC) component 1214, and a memory interface 1215.

The host interface 1211 may exchange a signal SGL with the host device 1100 through the signal connector 1250. The signal SGL may include a command, an address, data, and so forth. The host interface 1211 may interface the host device 1100 and the SSD 1200 according to the protocol of the host device 1100. For example, the host interface 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (DATA), serial advanced technology attachment (SATA), small computer system interface (SCSI), serial attached SCSI (SAS), peripheral component interconnection (PCI), PCI express (PCI-E) and universal flash storage (UFS).

The control component 1212 may analyze and process the signal SGL received from the host device 1100. The control component 1212 may control operations of internal function blocks according to a firmware or a software for driving the SSD 1200. The random access memory 1213 may be used as a working memory for driving such a firmware or software.

The ECC component 1214 may generate the parity data of data to be transmitted to at least one of the nonvolatile memory devices 1231 to 123n. The generated parity data may be stored together with the data in the nonvolatile memory devices 1231 to 123n. The ECC component 1214 may detect an error of the data read from at least one of the nonvolatile memory devices 1231 to 123n, based on the parity data. If a detected error is within a correctable range, the ECC component 1214 may correct the detected error.

The memory interface 1215 may provide control signals such as commands and addresses to at least one of the nonvolatile memory devices 1231 to 123n, according to control of the control component 1212. Moreover, the memory interface 1215 may exchange data with at least one of the nonvolatile memory devices 1231 to 123n, according to control of the control component 1212. For example, the memory interface 1215 may provide the data stored in the buffer memory device 1220, to at least one of the nonvolatile memory devices 1231 to 123n, or provide the data read from at least one of the nonvolatile memory devices 1231 to 123n, to the buffer memory device 1220.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured as any of various types of connectors depending on an interface scheme between the host device 1100 and the SSD 1200.

The power connector 1260 may be configured as any of various types of connectors depending on a power supply scheme of the host device 1100.

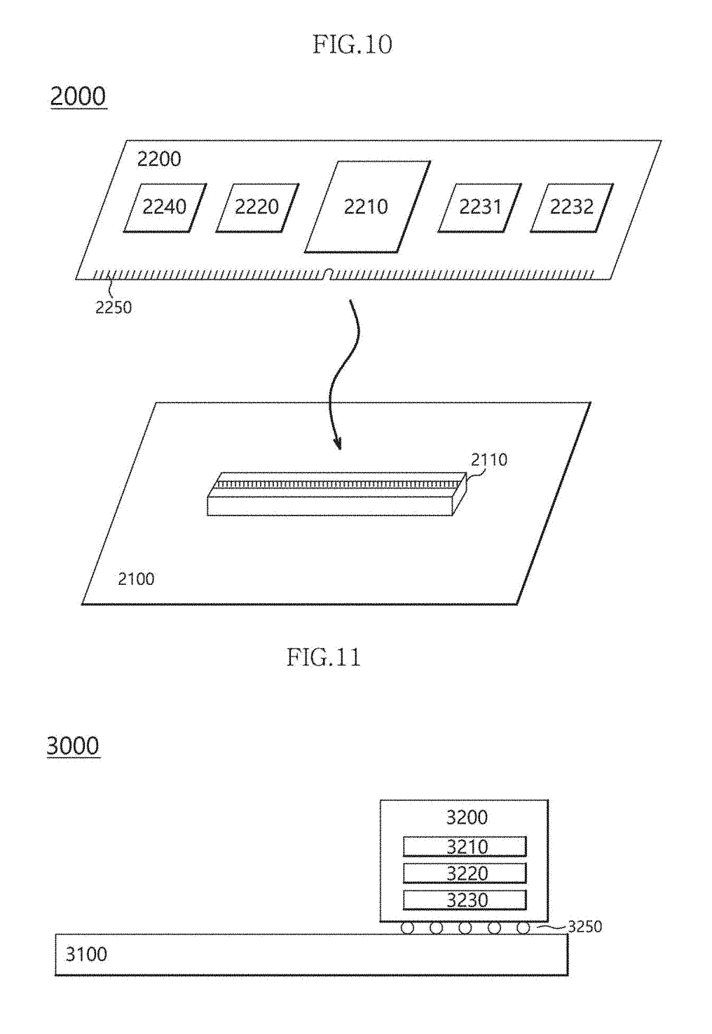

FIG. 10 is a diagram illustrating a data processing system 2000 including a memory system 2200 in accordance with an embodiment. Referring to FIG. 10, the data processing system 2000 may include a host device 2100 and the memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operations of the memory system 2200. The controller 2210 may be configured in the same manner as the controller 1210 shown in FIG. 9.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250 to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data, and the like, as well as power, may be transferred between the host device 2100 and the memory system 2200. The connection terminal 2250 may be configured into various types depending on an interface scheme between the host device 2100 and the memory system 2200. The connection terminal 2250 may be disposed on any one side of the memory system 2200.

FIG. 11 is a diagram illustrating a data processing system 3000 including a memory system 3200 in accordance with an embodiment. Referring to FIG. 11, the data processing system 3000 may include a host device 3100 and the memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operations of the memory system 3200. The controller 3210 may be configured in the same manner as the controller 1210 shown in FIG. 9.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

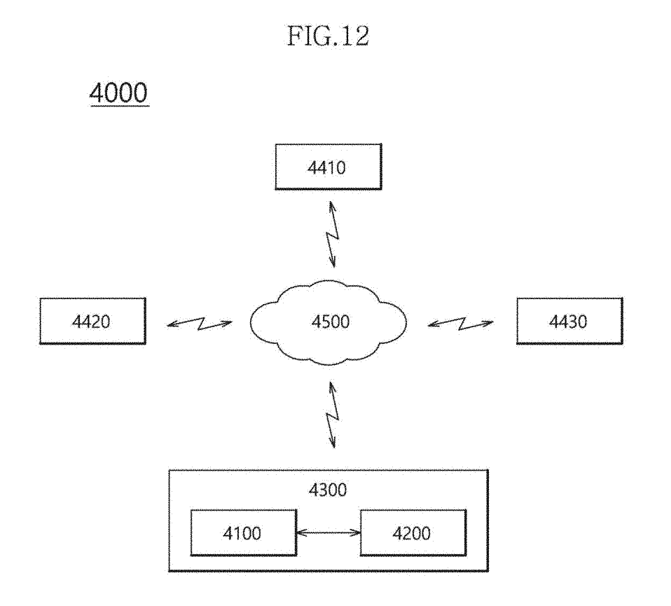

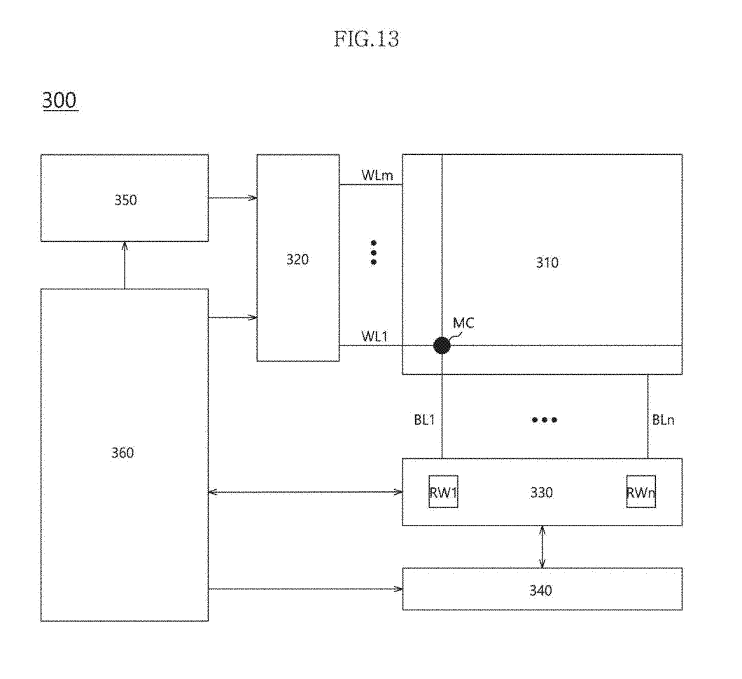

FIG. 12 is a diagram illustrating a network system 4000 including a memory system 4200 in accordance with an embodiment. Referring to FIG. 12, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured as the memory system 100 shown in FIG. 1, the memory system 1200 shown in FIG. 9, the memory system 2200 shown in FIG. 10 or the memory system 3200 shown in FIG. 11.

FIG. 13 is a block diagram illustrating a nonvolatile memory device 300 included in a memory system in accordance with an embodiment. Referring to FIG. 13, the nonvolatile memory device 300 may include a memory cell array 310, a row decoder 320, a data read/write block 330, a column decoder 340, a voltage generator 350, and control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

While various embodiments have been described above, it will be understood to those skilled in the art in light of this disclosure that various modifications may be made without departing from the spirit and scope of the present invention. Accordingly, the present invention is not limited to the described embodiments; rather, the present invention encompasses all modifications and variations that fall within the scope of the claims.

What is claimed is:

1. A memory system comprising:
a controller; and
a nonvolatile memory device comprising memory units, and configured to perform a read operation on the memory units according to control of the controller,
wherein the controller arranges a processing order of the memory units based on an internal read time of each of the memory units, and controls the read operation according to the arranged processing order.

2. The memory system of claim 1, wherein the nonvolatile memory device further comprises a data buffer, and
the internal read time of each of the memory units indicates a time required for reading data from the corresponding memory unit into the data buffer.

3. The memory system of claim 1, wherein each of the memory units is configured such that its internal read time decreases as the number of read voltages applied to the corresponding memory unit decreases, when the read operation is performed.

4. The memory system of claim 1, wherein the controller arranges the processing order in ascending order of the internal read times.

5. The memory system of claim 1, wherein the controller transmits addresses of the memory units to the nonvolatile memory device according to the arranged processing order to control the read operation.

6. The memory system of claim 1, wherein the nonvolatile memory device accesses the memory units in parallel, when performing the read operation.

7. The memory system of claim 1, wherein the nonvolatile memory device sequentially outputs data read from the memory units to the controller according to the arranged processing order.

8. A memory system comprising:
a controller; and
a nonvolatile memory device comprising memory units, and configured to perform a read operation on the memory units according to control of the controller,
wherein the controller arranges a processing order of the memory units based on levels of the memory units, and controls the read operation according to the arranged processing order.

9. The memory system of claim 8, wherein the level of each of the memory units is decided according to a level of a bit stored in the corresponding memory unit, among multi-level bits being able to be stored in a memory cell of the corresponding memory unit.

10. The memory system of claim 8, wherein the controller arranges the processing order in ascending order of internal read times of the memory units based on the levels of the memory units.

11. The memory system of claim 10, wherein the nonvolatile memory device further comprises a data buffer, and
the internal read time of each of the memory units indicates a time required for reading data from the corresponding memory unit into the data buffer.

12. The memory system of claim 10, wherein each of the memory units is configured such that its internal read time decreases as the number of read voltages applied to the corresponding memory unit decreases, when the read operation is performed.

13. The memory system of claim 8, wherein the controller transmits addresses of the memory units to the nonvolatile memory device according to the arranged processing order to control the read operation.

14. The memory system of claim 8, wherein the nonvolatile memory device read-accesses the memory units in parallel, when performing the read operation.

15. The memory system of claim 8, wherein the nonvolatile memory device sequentially outputs data read from the memory units to the controller according to the arranged processing order.

16. A memory system comprising:
a controller; and
a nonvolatile memory device comprising memory units, and configured to read-access the memory units in parallel at the same time according to control of the controller, and output data read from the memory units to the controller based on an output order,
wherein the controller arranges the output order based on levels of the memory units, when the levels of the memory units are different from each other.

17. The memory system of claim 16, wherein the level of each of the memory units is decided according to a level of a bit stored in the corresponding memory unit, among multi-level bits being able to be stored in a memory cell in the corresponding memory unit.

18. The memory system of claim 16, wherein the controller arranges the output order in ascending order of internal read time based on the levels.

19. The memory system of claim 18, wherein the nonvolatile memory device further comprises a data buffer, and
an internal read time of each of the memory units indicates a time required for reading data from the corresponding memory unit into the data buffer.

20. The memory system of claim 18, wherein each of the memory units is configured such that its internal read time decreases as the number of read voltages applied to the corresponding memory unit decreases, when the memory unit is read-accessed.

21. The memory system of claim 16, wherein the controller transmits addresses of the memory units to the nonvolatile memory device according to the arranged output order, and forces the nonvolatile memory device to follow the arranged output order.
